(19) United States
(12) Patent Application Publication
(10) Pub. No.: US 2015/0240704 A1
(43) Pub. Date: Aug. 27, 2015

(54) SUPERCHARGING APPARATUS FOR ENGINE

(71) Applicant: AISAN KOGYO KABUSHIKI KAISHA, Obu-shi (JP)

(72) Inventor: Mamoru YOSHIOKA, Nagoya-shi (JP)

(21) Appl. No.: 14/608,009

(22) Filed: Jan. 28, 2015

(30) Foreign Application Priority Data
Feb. 26, 2014 (JP) 2014-034840

(51) Int. Cl. F02B 33/40; F02B 39/04

(52) U.S. Cl. CPC F02B 33/40; F02B 39/04

(57) ABSTRACT

An intake bypass passage is provided between an intake passage downstream of a compressor and the intake passage upstream of the compressor and provided with an ABV. The ABV is a diaphragm valve in which a housing is defined by a diaphragm to form a pressure chamber. A valve seat is provided in the intake bypass passage, and a valve element provided integrally with the diaphragm is arranged to seat on the valve seat. The valve element is urged by a spring in a direction to seat on the valve seat. A pressure passage communicated with a surge tank downstream of a throttle valve is connected to the pressure chamber. The valve element is formed with a communication hole communicating the intake passage downstream of the compressor with the pressure chamber.

### CROSS-REFERENCE TO RELATED APPLICATIONS

This application is based upon and claims the benefit of priority from the prior Japanese Patent Application No. 2014-034840 filed on Feb. 26, 2014, the entire contents of which are incorporated herein by reference.

### BACKGROUND OF THE INVENTION

1. Field of the Invention

The present invention relates to a supercharging apparatus for an engine provided with a supercharger to increase intake pressure of the engine.

2. Related Art

Heretofore, in an engine provided with a supercharger, when a pressure difference between pressure at an inlet side and pressure at an outlet side of a compressor constituting the supercharger is too large, airflow on a wing surface of the compressor could be unstable and self-excited vibration is generated in the airflow, namely, “surging” might happen. In order to prevent this surging, an intake bypass passage configured to bypass an intake passage upstream of the compressor and an intake passage downstream of the compressor is provided, and an intake bypass valve is provided in the intake bypass passage. Then, this intake bypass valve is opened as necessary so that the pressure difference between the pressure at the inlet side and the pressure at the outlet side of the compressor is decreased to prevent surging.

In Japanese Patent Application Publication No. JPS60-150430A, there is described this type of intake bypass passage and an intake bypass valve annexed to a supercharger. The intake bypass valve is configured as a diaphragm valve to be opened by use of negative pressure generated in an intake passage (surge tank) downstream of a throttle valve. FIG. 10 is a schematic cross sectional view showing this type of intake bypass valve 71. This intake bypass valve 71 includes a housing 72, a diaphragm 74 configured to define an inside of the housing 72 as a pressure chamber 73, a plate-like valve element 75 provided in a center of the diaphragm 74, a valve seat 76 arranged to have the valve element 75 seated thereon, and a spring 77 configured to urge the valve element 75 in a direction to seat on the valve seat 76. The pressure chamber 73 is communicated to an intake passage (surge tank) downstream of the throttle valve through a pressure passage 78. When the throttle valve is closed during deceleration operation or others of the engine and pressure inside the surge tank turns negative, the negative pressure is introduced to the pressure chamber 73 through the pressure passage 78 connected to the surge tank. As a result, the diaphragm 74 is pulled against force of the spring 77. The valve element 75 is thus opened to communicate an intake bypass passage 79 with an intake passage 80 so that pressure difference between pressure at an inlet side and pressure at an outlet side of a compressor is reduced to prevent surging.

### SUMMARY OF INVENTION

### Problems to be Solved by the Invention

However, in the above intake bypass valve 71, supercharging pressure (pressure at the outlet side of the compressor) P1 acting on the intake passage 80 during supercharging of the engine becomes larger than surge tank pressure P3. Consequently, the force of the spring 77 has to be made strong and an external diameter of the diaphragm 74 has to be made large in order to maintain the valve-closed state of the valve element 75. As a result, the valve-opening responsiveness of the intake bypass valve 71 might turn worse.

Further, in an engine provided with an EGR apparatus, intake air containing EGR gas is got into the surge tank while EGR is performed. When the pressure in the surge tank is changed by switching acceleration and deceleration operations of the engine, the intake air containing EGR gas comes in and out of the pressure chamber 73 of the intake bypass valve 71 which is communicated with the surge tank. Thus, the EGR gas might remain in the pressure chamber 73 after stop of the engine. If this residual EGR gas in the pressure chamber 73 is cooled after stop of the engine, condensed water might be generated by moisture included in the EGR gas. As a consequence, normal operation of the diaphragm 74, the spring 77, and the housing 72 might be obstructed due to erosion of these elements or freeze of the condensed water.

The present invention has been made in view of the above circumstance and has a purpose to provide a supercharging apparatus for an engine capable of downsizing an intake bypass valve and enhancing a valve-opening responsiveness of the intake bypass valve. Another purpose of the present invention is, in addition to the above purpose, to provide a supercharging apparatus for an engine capable of scavenging gas and replacing it with fresh air inside a pressure chamber of the intake bypass valve.

### Means of Solving the Problems

To achieve the above purpose, one aspect of the invention provides a supercharging apparatus for an engine including: a supercharger provided between an intake passage and an exhaust passage of the engine and configured to increase intake pressure in the intake passage, the supercharger including a compressor placed in the intake passage, a turbine placed in the exhaust passage, and a rotary shaft connecting the compressor and the turbine so that the compressor and the turbine are integrally rotatable; an intake bypass passage configured to bypass the intake passage downstream of the compressor and the intake passage upstream of the compressor; an air bypass valve configured to open and close the intake bypass passage, the air bypass valve serving as a pressure-operated valve arranged to be operated by introducing intake pressure from the intake passage, and provided with: a housing; an operating member configured to define the housing and form a capacity-variable pressure chamber; a valve seat provided in the intake bypass passage; a valve element integrally provided with the operating member and arranged to seat on the valve seat; and a spring arranged to urge the valve element in a direction to seat on the valve seat; a pressure passage for introducing the intake pressure to the pressure chamber; and a throttle valve provided to adjust an intake amount in the intake passage, the pressure passage being communicated with the intake passage downstream of the throttle valve, wherein the valve element is provided with a communication hole communicating the intake passage downstream of the compressor with the pressure chamber.

### Advantageous Effects of Invention

According to the present invention, an intake bypass valve can be downsized and valve-opening responsiveness of the intake bypass valve can be enhanced. Further, gas inside a pressure chamber of the intake bypass valve can be scavenged and replaced with fresh air.

### BRIEF DESCRIPTION OF THE DRAWINGS

FIG. 1 is a schematic configuration view showing a gasoline engine system with a supercharger in a first embodiment;

FIG. 2 is a schematic cross sectional view showing an ABV and others in the first embodiment;

FIG. 3 is a graph showing a relation of a valve-opening pressure of a check valve with pressure of a surge tank and pressure at an outlet side of a compressor;

FIG. 4 is a schematic configuration view showing a gasoline engine system with a supercharger in a second embodiment;

FIG. 5 is a schematic cross sectional view showing an ABV and others in the second embodiment;

FIG. 6 is a flowchart showing processing details that an ECU carries out for a VSV in the second embodiment;

FIG. 7 is a flowchart showing processing details that an ECU carries out for a VSV in a third embodiment;

FIG. 8 is a schematic cross sectional view showing an ABV and others in a fourth embodiment;

FIG. 9 is a schematic cross sectional view showing an ABV and others in a fifth embodiment; and

FIG. 10 is a schematic cross sectional view showing an intake bypass valve and others according to a related art.

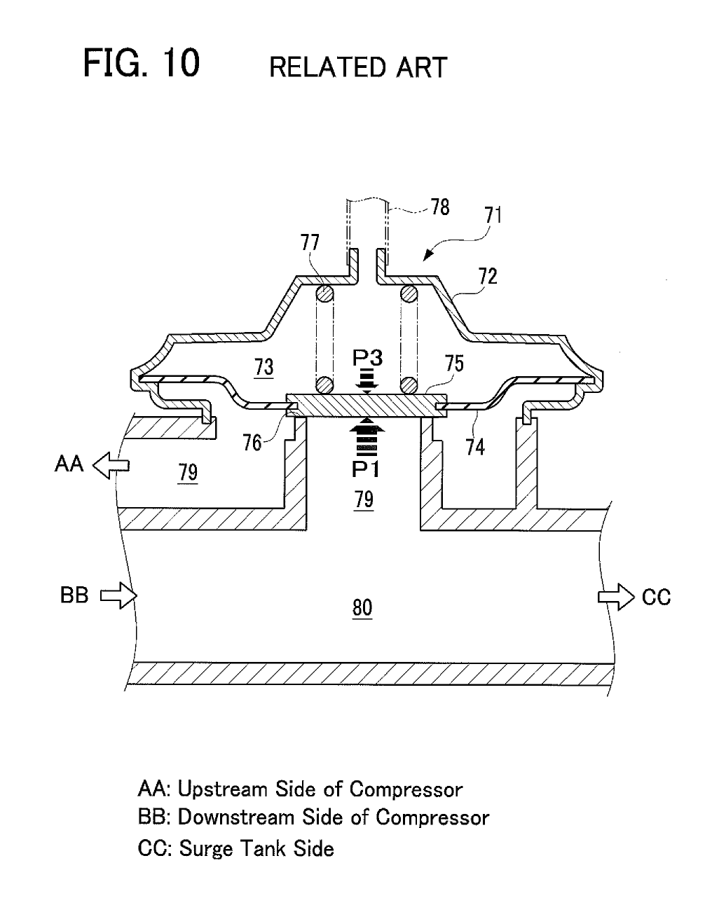

### DESCRIPTION OF EMBODIMENTS

### First Embodiment

A detailed description of a first embodiment embodying a supercharging apparatus for an engine of the present invention will now be given referring to the accompanying drawings.

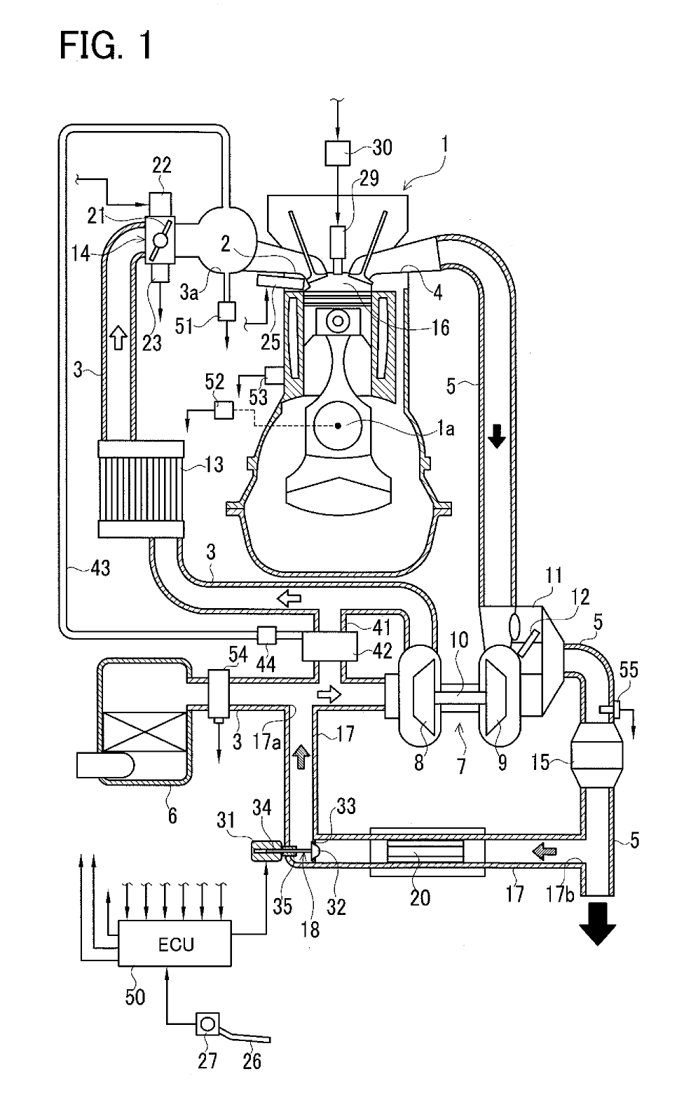

FIG. 1 is a schematic configuration view showing a gasoline engine system with a supercharger in the present embodiment. This engine system includes a reciprocating-type engine 1. This engine 1 has an intake port 2 connected to an intake passage 3 and an exhaust port 4 connected to an exhaust passage 5. An air cleaner 6 is provided at an inlet of the intake passage 3. In the intake passage 3 downstream of the air cleaner 6, a supercharger 7 is placed in a position between a portion of the intake passage 3 and a portion of the exhaust passage 5 to increase pressure of intake air in the intake passage 3.

The supercharger 7 includes a compressor 8 placed in the intake passage 3, a turbine 9 placed in the exhaust passage 5, and a rotary shaft 10 connecting the compressor 8 and the turbine 9 so that they are integrally rotatable. The supercharger 7 is configured to rotate the turbine 9 with exhaust gas flowing in the exhaust passage 5 and integrally rotate the compressor 8 through the rotary shaft 10 in order to increase the pressure of intake air in the intake passage 3, that is, carry out supercharging.

In the exhaust passage 5, adjacent to the supercharger 7, an exhaust bypass passage 11 is provided by detouring around the turbine 9. In this exhaust bypass passage 11, a waste gate valve 12 is placed. This waste gate valve 12 regulates exhaust gas allowed to flow in the exhaust bypass passage 11. Thus, a flow rate of exhaust gas to be supplied to the turbine 9 is regulated, thereby adjusting rotary speeds of the turbine 9 and the compressor 8, and adjusting supercharging pressure of the supercharger 7.

In the intake passage 3, an intercooler 13 is provided between the compressor 8 of the supercharger 7 and the engine 1. This intercooler 13 serves to cool intake air having the pressure increased by the compressor 8 and hence a high temperature, down to an appropriate temperature. A surge tank 3a is provided in the intake passage 3 between the intercooler 13 and the engine 1. Further, an electronic throttle device 14 this is an electrically-operated throttle valve is placed in the intake passage 3 downstream of the intercooler 13 but upstream of the surge tank 3a. The throttle device 14 includes a butterfly-shaped throttle valve 21 placed in the intake passage 3, a DC motor 22 to drive the throttle valve 21 to open and close, a throttle sensor 23 to detect an opening degree or position (a throttle opening degree) TA of the throttle valve 21. The throttle sensor 23 corresponds to one example of a throttle opening degree detecting unit of the invention. The throttle device 14 is configured so that the throttle valve 21 is driven by the DC motor 22 to open and close according to operation of an accelerator pedal 26 by a driver to adjust the opening degree of the throttle valve 21. In this embodiment, the throttle device 14 corresponds to one example of an intake regulating valve of the invention. In the exhaust passage 5 downstream of the turbine 9, a catalytic converter 15 is provided as an exhaust catalyst to clean exhaust gas.

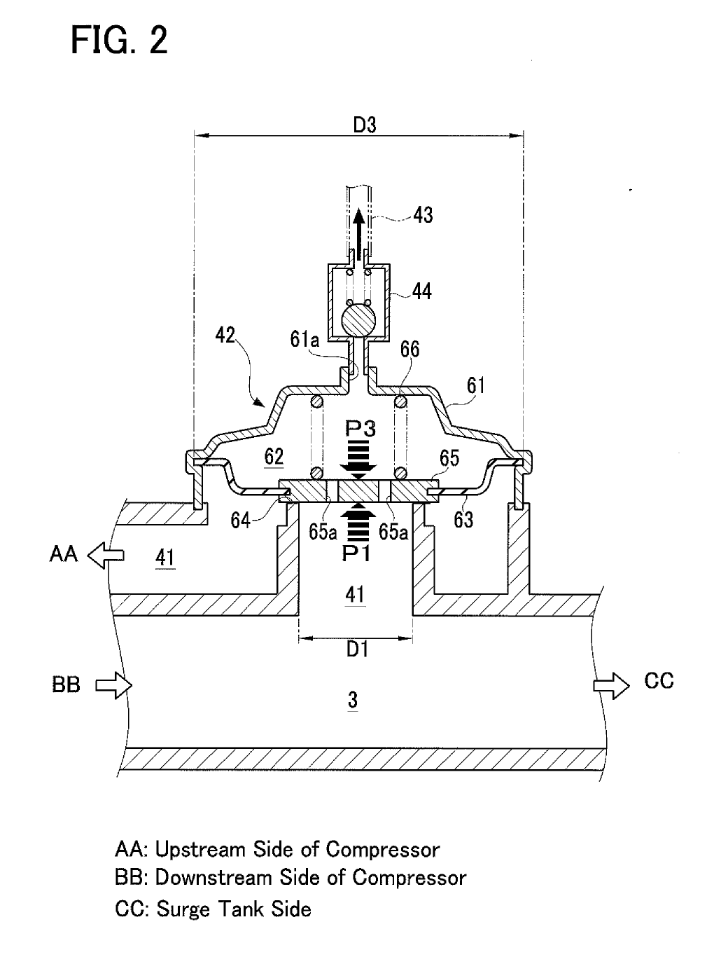

In the intake passage 3, adjacent to the supercharger 7, an intake bypass passage 41 is provided detouring around the compressor 8. Namely, the intake bypass passage 41 is configured to bypass a portion between the intake passage 3 downstream of the compressor 8 and the intake passage 3 upstream of the compressor 8. In this intake bypass passage 41, an air bypass valve (hereinafter, referred as ABV) 42 is provided to open and close the passage 41. The ABV 42 regulates intake air flowing in the intake bypass passage 41, and thereby a pressure difference between pressure at an inlet side and pressure at an outlet side of the compressor 8 is reduced so that generation of surge is prevented. The ABV 42 is provided with a pressure passage 43 configured to introduce pressure to a pressure chamber 62 (see FIG. 2) of the ABV 42. The pressure passage 43 has one end connected and communicated to the pressure chamber 62 of the ABV 42 and the other end connected and communicated to the surge tank 3a. In the pressure passage 43 near the ABV 42, a check valve 44 is provided. This check valve 44 is configured to allow gas to flow from the pressure chamber 62 to the surge tank 3a but to obstruct gas flow from the surge tank 3a to the pressure chamber 62. This check valve 44 corresponds to one example of an opening and closing unit of the invention.

The engine 1 is further provided with an injector 25 to inject and supply fuel into a combustion chamber 16. The injector 25 is configured to be supplied with the fuel from a fuel tank (not shown). The engine 1 is further provided with an ignition plug 29 in each cylinder. Each of the ignition plugs 29 ignites in response to high voltage output from an igniter 30. An ignition timing of each ignition plug 29 is determined by output timing of the high voltage from the igniter 30. The ignition plugs 29 and the igniter 30 constitute an ignition device.

In the present embodiment, the engine 1 is provided with an EGR apparatus for achieving high EGR rates. The EGR apparatus includes an exhaust gas recirculation (EGR) passage 17 allowing part of exhaust gas discharged from the combustion chamber 16 of the engine 1 to the exhaust passage 5 to flow in the intake passage 3 as EGR gas and return to the combustion chamber 16, and an exhaust gas recirculation (EGR) valve 18 placed in the EGR passage 17 to regulate an exhaust gas flow rate in the EGR passage 17. In this embodiment, the EGR apparatus is a low pressure loop system and the EGR passage 17 is provided to extend between the exhaust passage 5 downstream of the catalytic converter 15 and the intake passage 3 upstream of the compressor 8. Specifically, an outlet 17a of the EGR passage 17 is connected to the intake passage 3 upstream of the compressor 8 to allow a part of exhaust gas flowing in the exhaust passage 5 to flow as EGR gas into the intake passage 3 through the EGR passage 17 and to return to the combustion chamber 16. An inlet 17b of the EGR passage 17 is connected to the exhaust passage 5 downstream of the catalytic converter 15. In the EGR passage 17, an EGR cooler 20 is provided to cool EGR gas flowing in the EGR passage 17. In the present embodiment, the EGR valve 18 is located in the EGR passage 17 downstream of the EGR cooler 20.

As shown in FIG. 1, the EGR valve 18 is configured as a poppet valve and a motor-operated valve. Specifically, the EGR valve 18 is provided with a valve element 32 to be driven by a DC motor 31. The valve element 32 has an almost conical shape and is configured to seat on a valve seat 33 provided in the EGR passage 17. The DC motor 31 includes an output shaft 34 arranged to reciprocate in a straight line (stroke movement). The valve element 32 is fixed at a leading end of the output shaft 34. The output shaft 34 is supported in a housing defining the EGR passage 17 through a bearing 35. The stroke movement of the output shaft 34 of the DC motor 31 is performed to adjust an opening degree of the valve element 32 with respect to the valve seat 33. The output shaft 34 of the EGR valve 18 is provided to be able to make stroke movement by a predetermined stroke between a fully closed position in which the valve element 32 seats on the valve seat 33 and a fully opened position in which the valve element 32 contacts with the bearing 35. In the present embodiment, an opening area of the valve seat 33 is set larger than a conventional one in order to achieve high EGR rates. Accordingly, the valve element 32 is also designed with large size.

In the present embodiment, for respectively executing fuel injection control, ignition timing control, intake amount control, EGR control, supercharging control, and other controls according to the operating condition of the engine 1, an electronic control unit (ECU) 50 controls the injector 25, the igniter 30, the DC motor 22 of the electronic throttle device 14, and the DC motor 31 of the EGR valve 18 according to the operating condition of the engine 1. The ECU 50 includes a central processing unit (CPU), various memories that store a predetermined control program and others in advance and that temporarily store computational results and others of the CPU, and an external input circuit and an external output circuit connected to each of them. In the present embodiment, the ECU 50 is one example of a control unit of the invention. To the external output circuit, there are connected the igniter 30, the injector 25, the DC motor 22, and the DC motor 31. To the external input circuit, there are connected the throttle sensor 23 and various sensors 27 and 51 to 55, that correspond to one example of an operating condition detecting unit to detect the operating condition of the engine 1, to transmit various engine signals to the external input circuit.

The various sensors include the accelerator sensor 27, the intake pressure sensor 51, the rotation speed sensor 52, the water temperature sensor 53, the air flow meter 54, and the air-fuel ratio sensor 55 as well as the throttle sensor 23. The accelerator sensor 27 detects an accelerator opening degree ACC which is an operation amount of an accelerator pedal 26. The intake pressure sensor 51 detects intake pressure PM in the surge tank 3a. That is, the intake pressure sensor 51 is configured to detect the intake pressure PM in the surge tank 3a downstream of the throttle valve 21. The rotation speed sensor 52 detects the rotation angle (crank angle) of a crank shaft 1a of the engine 1 and also detects changes in crank angle as the rotation speed (engine rotation speed) NE of the engine 1. The water temperature sensor 53 detects the cooling water temperature THW of the engine 1. The air flow meter 54 detects a flow amount Ga of intake air flowing in the intake passage 3 directly downstream of the air cleaner 6. The air-fuel ratio sensor 55 is placed in the exhaust passage 5 directly upstream of the catalytic converter 15 to detect an air-fuel ratio A/F in the exhaust gas.

In the present embodiment, the ECU 50 is configured to control the EGR valve 18 in the whole operating region of the engine 1 to carry out EGR according to the operating condition of the engine 1. On the other hand, the ECU 50 is arranged to normally control the EGR valve 18 to open based on the operating condition which is detected during acceleration operation or steady operation of the engine 1 and to control the EGR valve 18 to fully close during stop operation, idle operation, or deceleration operation of the engine 1.

In the present embodiment, the ECU 50 is arranged to control the electronic throttle device 14 based on the accelerator opening degree ACC in order to drive the engine 1 in response to requests from a driver. The ECU 50 is further arranged to control the electronic throttle device 14 to open based on the accelerator opening degree ACC during acceleration operation or steady operation of the engine 1 and to control the electronic throttle device 14 to close during stop or deceleration operation of the engine 1. Accordingly, the throttle valve 21 is opened during acceleration operation or steady operation of the engine 1, whereas it is fully closed during stop or deceleration operation of the engine 1.

Configuration of the ABV 42 is now explained. FIG. 2 is a schematic cross sectional view of the ABV 42 and others. The ABV 42 corresponds to a pressure-operated valve in the invention, operated by introducing intake pressure from the intake passage 3. To be specific, as shown in FIG. 2, the ABV 42 is configured as a diaphragm valve to be opened by use of negative pressure generated in the intake passage (surge tank 3a) downstream of the throttle valve 21. This ABV 42 is integrally provided with a housing 61, a diaphragm 63 as an operating member of the invention configured to define an inside of the housing 61 and form a capacity-variable pressure chamber 62, a valve seat 64 provided in the intake bypass passage 41, a plate-like valve element 65 integrally provided in a center of the diaphragm 63 and arranged to seat on the valve seat 64, and a spring 66 configured to urge the valve element 65 in a direction to seat on the valve seat 64. The pressure chamber 62 is communicated to the surge tank 3a downstream of the throttle valve 21 through the pressure passage 43 so that the intake pressure is introduced into the pressure chamber 62. The valve element 65 is formed with minute communication holes 65a penetrating through the valve element 65 in a plate thickness direction so that the intake passage 3 downstream of the compressor 8 and the pressure chamber 62 are slightly communicated to each other.

When the throttle valve 21 is closed during deceleration operation and others of the engine 1 and the surge tank 3a is under negative pressure, this negative pressure acts on the pressure chamber 62 through the pressure passage 43 to pull the diaphragm 63 against force of the spring 66. Thus, the valve element 65 is opened and the intake bypass passage 41 is communicated between the intake passage 3 upstream of the compressor 8 and the intake passage 3 downstream of the compressor 8. As a result, the pressure difference between the pressure at the inlet side and the pressure at the outlet side of the compressor 8 can be reduced, so that generation of surge in the intake passage 3 can be prevented.

The housing 61 is formed with a communication port 61a configured to communicate the pressure chamber 62 with the pressure passage 43. This communication port 61a has an opening area set to be larger than a total opening area of the plurality of communication holes 65a formed in the valve element 65. In the present embodiment, a check valve 44 is provided in the communication port 61a, and this check valve 44 is connected to one end of the pressure passage 43 while the other end of the pressure passage 43 is connected to the surge tank 3a.

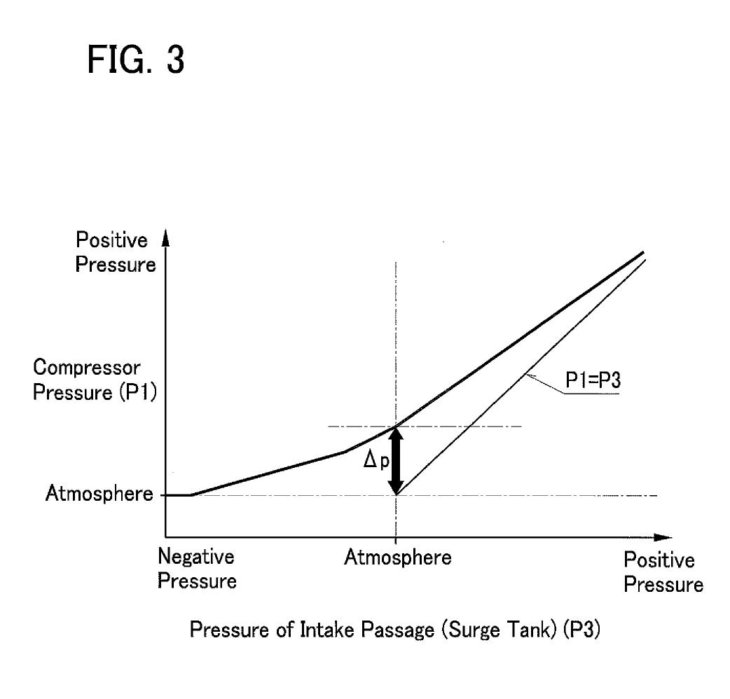

FIG. 3 is a graph showing a relation of a valve-opening pressure ΔP of the check valve 44 with a pressure (surge tank pressure) P3 of the surge tank 3a and a pressure (compressor-outlet-side pressure, i.e., supercharging pressure) P1 at an outlet side of the compressor 8. In the graph, a bold line indicates a lower limit of the valve-opening pressure ΔP of the check valve 44, and a solid line indicates the compressor-outlet-side pressure P1. The difference between the bold line and the solid line is a pressure difference Δp. In the present embodiment, since the valve element 65 is formed with the communication holes 65a, the compressor-outlet-side pressure P1 is almost equal to the surge tank pressure P3. Herein, when it is assumed that the relation between the valve-opening pressure ΔP of the check valve 44 and the pressure difference Δp is defined as “ΔP>Δp+α (α is a predetermined value),” the check valve 44 is not opened in the supercharging region of the engine 1, and therefore the compressor-outlet-side pressure P1 and the surge tank pressure P3 are almost equated by providing the communication holes 65a in the valve element 65.

According to the above explained supercharging apparatus for the engine of the present invention, the compressor-outlet-side pressure P1 acts on one surface of the valve element 65 of the ABV 42 while the surge tank pressure P3 acts on the other surface of the valve element 65 in the pressure chamber 62. In order to maintain a valve-closed state of the valve element 65, sum of the surge tank pressure P3 and the force of the spring 66 needs to be larger than the compressor-outlet-side pressure P1. Especially during supercharging of the engine 1, in order to prevent the valve element 65 from being opened due to the action of the compressor-outlet-side pressure P1 as the supercharging pressure, the force of the spring 66 needs to be relatively strong, and the valve-opening responsiveness of the valve element 65 is prone to be lowered to the extent of thus strengthened spring force. In the present embodiment, the valve element 65 of the ABV 42 is provided with the communication holes 65a configured to slightly communicate the intake passage 3 downstream of the compressor 8 with the pressure chamber 62. Accordingly, during supercharging of the engine 1, the pressure difference between the compressor-outlet-side pressure P1 (supercharging pressure) exerted on the valve element 65 and the surge tank pressure P3 is remarkably reduced, so that it becomes possible to make the force of the spring 66 relatively small as for maintaining the valve element 65 in the valve-closed state. Consequently, the external diameter of the diaphragm 63 can be made considerably small and the ABV 42 can be downsized, thus enhancing the valve-opening responsiveness of the ABV 42.

On the other hand, during deceleration operation of the engine 1, the surge tank pressure P3 turns negative and the negative pressure acts on the pressure chamber 62 from the pressure passage 43. Thereby, gas is allowed to flow into the pressure chamber 62 through the communication holes 65a of the valve element 65. In the present embodiment, the EGR apparatus is provided in the engine 1 so that EGR gas is allowed to flow into the surge tank 3a. Since the surge tank pressure P3 acts on the pressure chamber 62 to open and close the valve element 65, EGR gas could intrude into and remain in the pressure chamber 62, having a possibility of malfunction such as generation of condensed water. In contrast, the present embodiment can achieve introduction of fresh air to the pressure chamber 62 as mentioned above, and the residual EGR gas can be scavenged and replaced with this fresh air in the pressure chamber 62. Specifically, before stop of the engine 1, while the engine 1 is under deceleration operation with light-load, the EGR valve 18 is closed to cut off EGR, and the surge tank pressure P3 turns negative. Then, the fresh air is introduced to the pressure chamber 62 from the communication holes 65a of the valve element 65 in the ABV 42, and the EGR gas remained in the pressure chamber 62 is scavenged to the surge tank 3a. Thereby, malfunction of generating condensed water in the pressure chamber 62 can be prevented. Further, the ABV 42 can be downsized and therefore flexibility of ABV's mounting restriction to a vehicle can be enhanced.

According to the present embodiment, the pressure introduction from the pressure passage 43 to the pressure chamber 62 is shut off by the check valve 44, and thereby the pressure exerted on both surfaces of the valve element 65 is almost equated. As a result, the force of the spring 66 to close the valve element 65 can be made small, further enhancing the valve-opening responsiveness of the ABV 42. It is thus made relatively simplified the configuration to shut off the pressure introduction from the pressure passage 43 to the pressure chamber 62 by the check valve 44. Accordingly, it is possible to simplify the configuration to close the ABV 42 when the surge tank pressure P3 is positive.

In the present embodiment, an opening area of the communication port 61a formed in the housing 61 is made larger than the total opening area of the communication holes 65a of the valve element 65. Therefore, the surge tank pressure P3 acting on the pressure chamber 62 from the pressure passage 43 effectively acts on the diaphragm 63 even if the valve element 65 is provided with the communication holes 65a. Accordingly, function of the ABV 42 is ensured even if the valve element 65 of the ABV 42 is provided with the communication holes 65a.

### Second Embodiment

A second embodiment of the invention embodying a supercharging apparatus for an engine is now explained with referring to the accompanying drawings.

In each of the following embodiments, similar or identical elements to those in the first embodiment are given the same reference signs as in the first embodiment. The following explanation will be made with a focus on differences from the first embodiment.

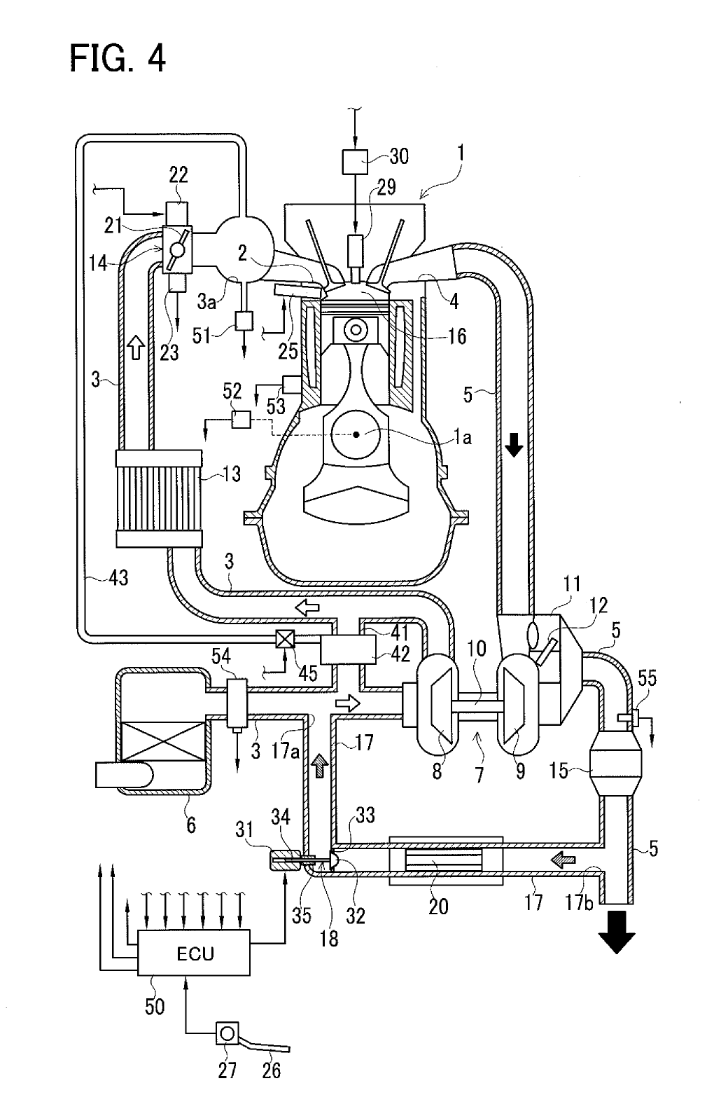

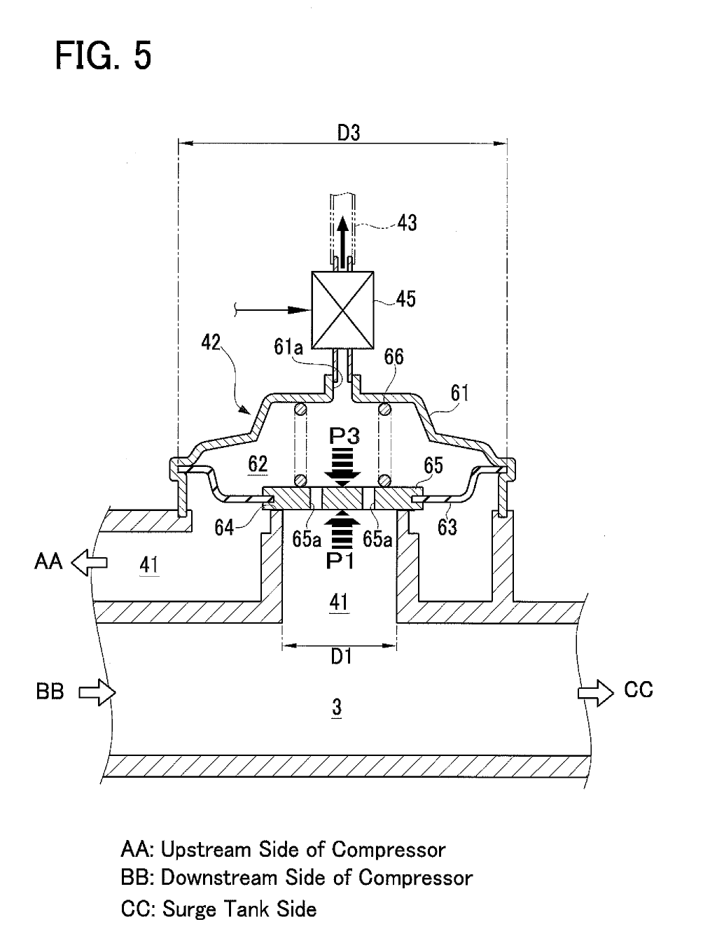

FIG. 4 is a schematic configuration view showing a gasoline engine system with a supercharger in the present embodiment. FIG. 5 is a schematic cross sectional view showing an ABV 42 and others. In the present embodiment, a vacuum switching valve (VSV) 45 is provided instead of the check valve 44 of the first embodiment. This VSV 45 is arranged to be controlled by the ECU 50 according to the operation condition of the engine 1. The VSV 45 corresponds to one example of an opening and closing unit and a motor-operated valve in the invention.

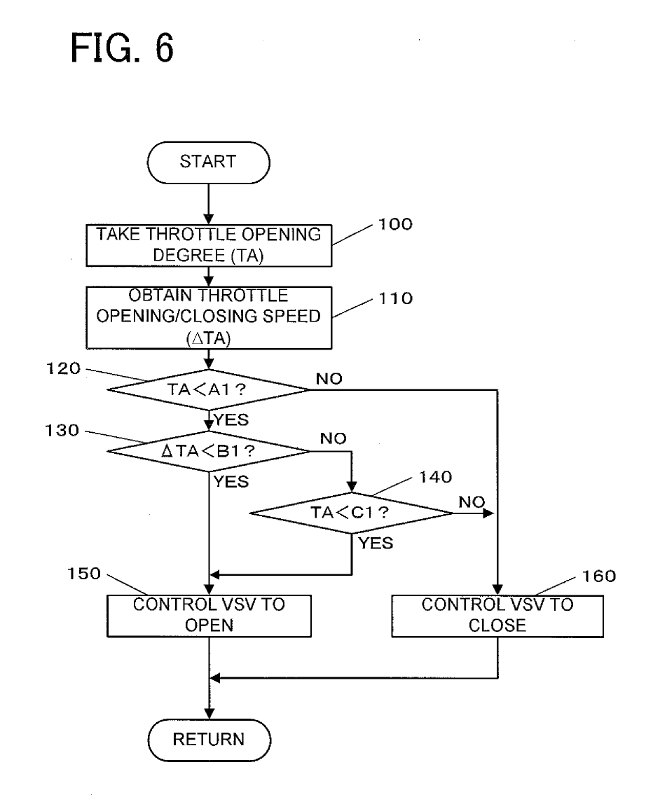

FIG. 6 is a flowchart showing processing details that the ECU 50 carries out for the VSV 45. When the processing proceeds to this routine, the ECU 50 first takes or reads a throttle opening degree TA based on a detected value detected by the throttle sensor 23 in Step 100.

In Step 110, the ECU 50 obtains a throttle opening/closing speed ΔTA. The ECU 50 can obtain the throttle opening/closing speed ΔTA from a difference between the throttle opening degree TA at this time and the throttle opening degree TA at the preceding time.

In Step 120, the ECU 50 determines whether or not the throttle opening degree TA is smaller than a predetermined first reference value A1. If this determination result is affirmative (YES), the ECU 50 shifts the process to Step 130. If the determination result is negative (NO), the ECU 50 shifts the process to Step 160 to control the VSV 45 to close and returns the process to Step 100.

In Step 130, the ECU 50 determines whether or not the throttle opening/closing speed ΔTA is smaller than a predetermined second reference value B1. If this determination result is affirmative, the ECU 50 shifts the process to Step 150. If this determination result is negative, the ECU 50 shifts the process to Step 140.

In Step 150, the ECU 50 controls the VSV 45 to open and returns the process to Step 100.

In Step 140, the ECU 50 determines whether or not the throttle opening degree TA is smaller than a predetermined third reference value C1. If this determination result is negative, the ECU 50 shifts the process to Step 160. If this determination result is affirmative, the ECU 50 shifts the process to Step 150.

According to the above control, the ECU 50 is arranged to obtain the throttle opening/closing speed ΔTA from the detected throttle opening degree TA and control the VSV 45 to open and close based on the throttle opening degree TA and the throttle opening/closing speed ΔTA.

According to the above mentioned supercharging apparatus for the engine in the present embodiment, in addition to the operational effects of the first embodiment, the following operational effects are achieved. Specifically, pressure introduction from the pressure passage 43 to the pressure chamber 62 of the ABV 42 can be shut off by the VSV 45 in accordance with the operation condition of the engine 1. Thereby, the ABV 42 can be properly closed in accordance with the operation condition of the engine 1.

In the present embodiment, since the VSV 45 is controlled to open and close based on the throttle opening degree TA and the throttle opening/closing speed ΔTA, the pressure introduction from the pressure passage 43 to the pressure chamber 62 of the ABV 42 can be shut off by the VSV 45 in accordance with the acceleration operation (supercharging) or the deceleration operation (non-supercharging) of the engine 1. Therefore, the ABV 42 can be properly opened or closed according to the supercharging or non-supercharging of the engine 1. Further, in the present embodiment, during supercharging of the engine 1, that is to say, when the EGR valve 18 is opened and EGR gas is let flow in the EGR passage 17, the VSV 45 is closed. The pressure introduction from the pressure passage 43 to the pressure chamber 62 is accordingly shut off by the VSV 45 at the time when the EGR gas is let flow from the EGR passage 17 to the intake passage 3. Thus, in supercharging the engine 1, the EGR gas can be prevented from flowing into the pressure chamber 62 of the ABV 42 from the surge tank 3a.

### Third Embodiment

A third embodiment of the invention embodying a supercharging apparatus for an engine is now explained in detail with referring to the accompanying drawings.

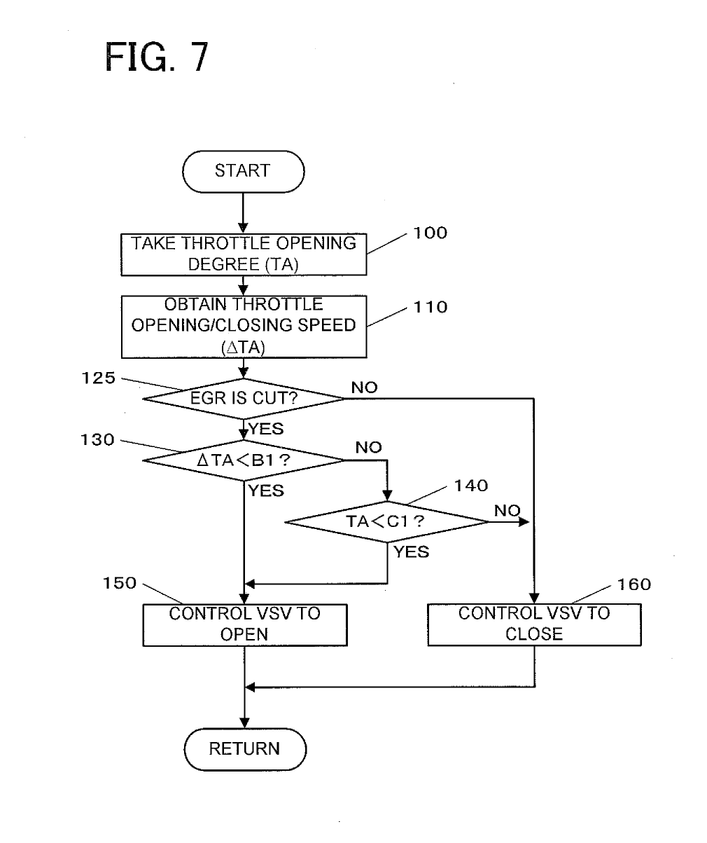

In the present embodiment, processing details of the VSV 45 is different from that of the second embodiment. FIG. 7 is a flowchart showing the processing details that the ECU 50 carries out for the VSV 45. The flowchart in FIG. 7 is different from FIG. 6 in that a Step 125 is provided instead of Step 120 in FIG. 6.

In a routine of the flowchart shown in FIG.7, after processing Steps 100 and 110, the ECU 50 determines whether or not EGR cut is performed, specifically, whether or not the EGR valve 18 is closed in Step 125. If this determination result is affirmative, the ECU 50 shifts the process to Step 130. If this determination result is negative, the ECU 50 shifts the process to Step 160.

Consequently, the present embodiment can achieve the similar operational effects with the second embodiment.

### Fourth Embodiment

A fourth embodiment of the invention embodying a supercharging apparatus for an engine is now explained in detail with referring to the accompanying drawings.

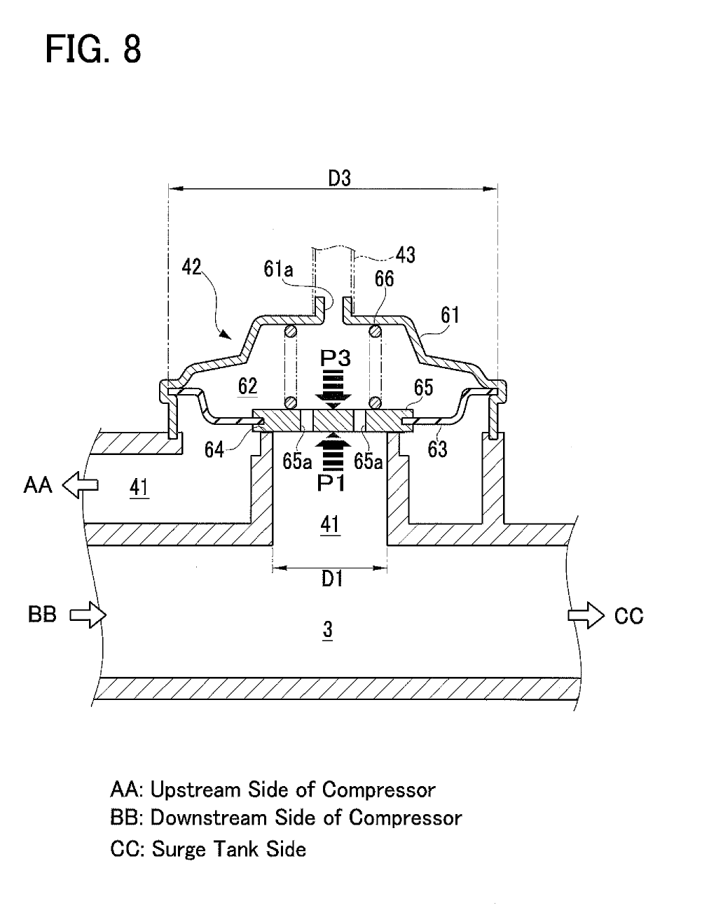

FIG. 8 is a schematic cross sectional view of the ABV 42 and others. In the present embodiment, the configuration is different from each of the above embodiments in a manner that the check valve 44 and the VSV 45 provided in the pressure passage 43 of the above embodiments are omitted.

Accordingly, in the present embodiment, unlike each of the above embodiments, introduction of supercharging pressure from the pressure passage 43 to the pressure chamber 62 of the ABV 42 cannot be selectively regulated but the valve element 65 of the ABV 42 is provided with communication holes 65a, so that force of the spring 66 can be made relatively small. Therefore, an external diameter of the diaphragm 63 can be made short to the most extent and the ABV 42 can be downsized, thus enhancing the valve-opening responsiveness of the ABV 42. Moreover, fresh air can be introduced from the communication holes 65a of the valve element 65 to the pressure chamber 62, and EGR gas present in the pressure chamber 62 can be scavenged to the surge tank 3a. Thus, malfunction of generating condensed water in the pressure chamber 62 can be prevented. Furthermore, the ABV 42 can be downsized and flexibility of mounting restriction to a vehicle can be enhanced.

### Fifth Embodiment

A fifth embodiment of the invention embodying a supercharging apparatus for an engine is now explained in detail with referring to the accompanying drawings.

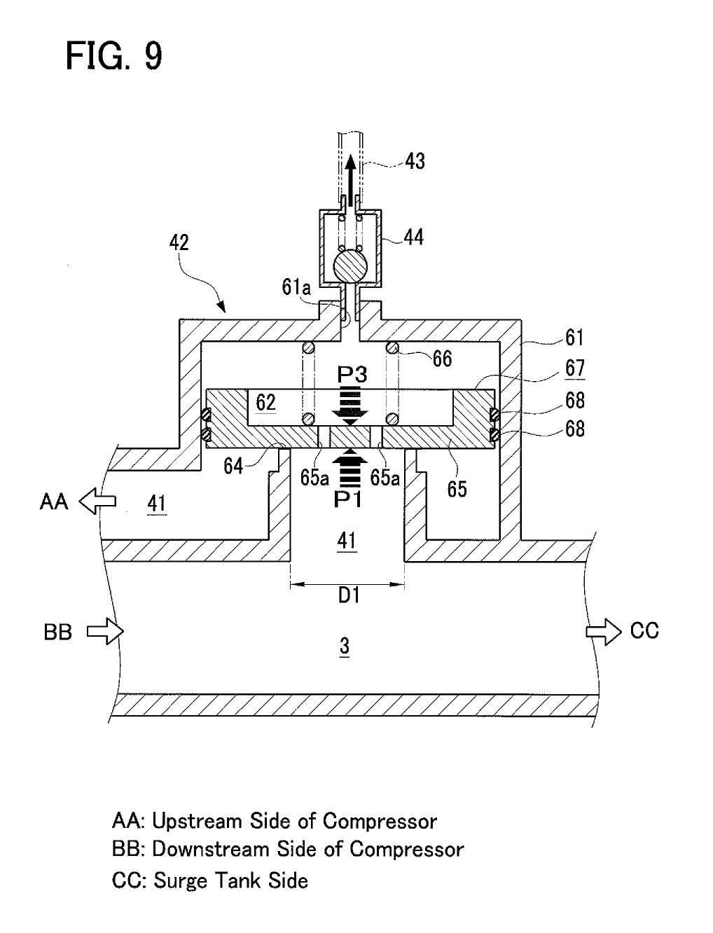

FIG. 9 is a schematic cross sectional view of the ABV 42 and others. In the present embodiment, the configuration of the ABV 42 is different from each one of the above embodiments.

As shown in FIG. 9, the ABV 42 is a piston valve serving as a pressure-operated valve and is formed with a piston 67 as an operating member of the invention, the piston 67 being configured to move in the housing 61 operated as a cylinder. The valve element 65 is integrally provided with the piston 67. Specifically, the piston 67 is of flat bottom-closed cylindrical shape, and a bottom wall of the piston 67 serves as the valve element 65. The piston 67 has an outer circumferential wall formed with seal rings 68 for ensuring airtightness. Further, the housing 61 includes the communication port 61a provided with the check valve 44 as similar to the first embodiment. Other configuration of the ABV 42 is similar to that of the ABV 42 in each of the above embodiments. When intake pressure is introduced in the pressure chamber 62, the piston 67 is moved upward and downward in the housing 61 as a cylinder so that capacity of the pressure chamber 62 is changed. By this movement of the piston 67, the valve element 65 is operated to open and close with respect to the valve seat 64.

Accordingly, in the present embodiment, when negative pressure in the surge tank 3a acts on the pressure chamber 62 through the pressure passage 43, so that the piston 67 is moved upward against the force of the spring 66. Thus, the valve element 65 is opened to communicate the intake bypass passage 41 between the intake passage 3 upstream of the compressor 8 and the intake passage 3 downstream of the compressor 8. As a result, the pressure difference between the pressure at the inlet side and the pressure at the outlet side of the compressor 8 can be reduced, thereby preventing generation of surge in the intake passage 3.

In the present embodiment, the valve element 65 of the ABV 42 is formed with the communication holes 65a configured to slightly communicate the intake passage 3 downstream of the compressor 8 with the pressure chamber 62, and thereby the pressure difference between the compressor-outlet-side pressure (supercharging pressure) P1 exerted on the valve element 65 and the surge tank pressure P3 is considerably lowered. As a result, it becomes possible to relatively lower the force of the spring 66 to maintain the valve-closed state of the valve element 65. Consequently, an external diameter of the piston 67 can be made small to the most extent and the ABV 42 can be downsized, thus enhancing the valve-opening responsiveness of the ABV 42. Other than this, the present embodiment can basically achieve the operational effects similar to the first embodiment.

The present invention is not limited to each of the above embodiments and a part of the configuration may be changed and modified as appropriate without departing from the scope of the invention.

In each of the above embodiments, a supercharging apparatus for an engine of the invention is embodied as an engine system with an EGR apparatus, but may be embodied as an engine system with no EGR apparatus provided.

While the presently preferred embodiments of the present invention have been shown and described, it is to be understood that this disclosure is for the purpose of illustration and that various changes and modifications may be made without departing from the scope of the invention as set forth in the appended claims.

### INDUSTRIAL APPLICABILITY

The present invention is, for example, utilizable for a gasoline engine system mounted on an automobile.

### REFERENCE SIGNS LIST

1 Engine

3 Intake passage

3a Surge tank

7 Supercharger

8 Compressor

9 Turbine

10 Rotary shaft

14 Electronic throttle device (Intake regulating valve)

17 EGR passage

17a Outlet

17b Inlet

18 EGR valve

21 Throttle valve

23 Throttle sensor (Throttle opening degree detecting unit)

41 Intake bypass passage

42 ABV (Air bypass valve)

43 Pressure passage

44 Check valve (Opening and closing unit)

45 VSV (Opening and closing unit, motor-operated valve)

50 ECU (Control unit)

61 Housing

61a Communication port

62 Pressure chamber

63 Diaphragm (Operation body)

64 Valve seat

65 Valve element

65a Communication hole

66 Spring

67 Piston (Operating member)

TA Throttle opening degree

ΔTA Throttle opening/closing speed

What is claimed is:

1. A supercharging apparatus for an engine including:
a supercharger provided between an intake passage and an exhaust passage of the engine and configured to increase intake pressure in the intake passage,
the supercharger including a compressor placed in the intake passage, a turbine placed in the exhaust passage, and a rotary shaft connecting the compressor and the turbine so that the compressor and the turbine are integrally rotatable;
an intake bypass passage configured to bypass the intake passage downstream of the compressor and the intake passage upstream of the compressor;
an air bypass valve configured to open and close the intake bypass passage,
the air bypass valve serving as a pressure-operated valve arranged to be operated by introducing intake pressure from the intake passage, and provided with: a housing; an operating member configured to define the housing and form a capacity-variable pressure chamber; a valve seat provided in the intake bypass passage; a valve element integrally provided with the operating member and arranged to seat on the valve seat; and a spring arranged to urge the valve element in a direction to seat on the valve seat;
a pressure passage for introducing the intake pressure to the pressure chamber; and
a throttle valve provided to adjust an intake amount in the intake passage,
the pressure passage being communicated with the intake passage downstream of the throttle valve,
wherein the valve element is provided with a communication hole communicating the intake passage downstream of the compressor with the pressure chamber.

2. The supercharging apparatus for an engine according to claim 1, further including an opening and closing unit configured to open and close the pressure passage.

3. The supercharging apparatus for an engine according to claim 2, wherein the opening and closing unit is a check valve.

4. The supercharging apparatus for an engine according to claim 2, wherein the opening and closing unit is an electronic valve and the supercharging apparatus further includes a control device for controlling the electronic valve according to an operation condition of the engine.

5. The supercharging apparatus for an engine according to claim 4, further including a throttle opening degree detecting unit configured to detect an opening degree of the throttle valve as a throttle opening degree,
wherein the control device is configured to obtain a throttle opening/closing speed from the detected throttle opening degree and to control the electronic valve to open based on the throttle opening degree and the throttle opening/closing speed.

6. The supercharging apparatus for an engine according to claim 4, further including an exhaust gas recirculation passage configured to flow a part of exhaust gas exhausted from a combustion chamber of the engine to the exhaust passage as exhaust recirculation gas to the intake passage so that the gas is recirculated to the combustion chamber and an exhaust gas recirculation valve configured to regulate flow of the exhaust recirculation gas in the exhaust gas recirculation passage,
wherein the control device is configured to control the electronic valve to close when the exhaust gas recirculation valve is opened to flow the exhaust recirculation gas to the exhaust gas recirculation passage.

7. The supercharging apparatus for an engine according to claim 5, further including an exhaust gas recirculation passage configured to flow a part of exhaust gas exhausted from a combustion chamber of the engine to the exhaust passage as exhaust recirculation gas to the intake passage so that the gas is recirculated to the combustion chamber and an exhaust gas recirculation valve configured to regulate flow of the exhaust recirculation gas in the exhaust gas recirculation passage,
wherein the control device is configured to control the electronic valve to close when the exhaust gas recirculation valve is opened to flow the exhaust recirculation gas to the exhaust gas recirculation passage.

8. The supercharging apparatus for an engine according to claim 1, wherein
the housing is formed with a communication port to communicate the pressure chamber with the pressure passage, and
the communication port has an opening area larger than an opening area of the communication hole.

9. The supercharging apparatus for an engine according to claim 2, wherein
the housing is formed with a communication port to communicate the pressure chamber with the pressure passage, and
the communication port has an opening area larger than an opening area of the communication hole.

10. The supercharging apparatus for an engine according to claim 3, wherein
the housing is formed with a communication port to communicate the pressure chamber with the pressure passage, and
the communication port has an opening area larger than an opening area of the communication hole.

11. The supercharging apparatus for an engine according to claim 4, wherein
the housing is formed with a communication port to communicate the pressure chamber with the pressure passage, and
the communication port has an opening area larger than an opening area of the communication hole.

12. The supercharging apparatus for an engine according to claim 5, wherein
the housing is formed with a communication port to communicate the pressure chamber with the pressure passage, and
the communication port has an opening area larger than an opening area of the communication hole.

13. The supercharging apparatus for an engine according to claim 6, wherein
the housing is formed with a communication port to communicate the pressure chamber with the pressure passage, and
the communication port has an opening area larger than an opening area of the communication hole.

14. The supercharging apparatus for an engine according to claim 1, wherein
the pressure-operated valve is a diaphragm valve and the operating member is a diaphragm, and
the valve element is formed integrally with the diaphragm.

15. The supercharging apparatus for an engine according to claim 2, wherein
the pressure-operated valve is a diaphragm valve and the operating member is a diaphragm, and
the valve element is formed integrally with the diaphragm.

16. The supercharging apparatus for an engine according to claim 1, wherein
the pressure-operated valve is a piston valve and the operating member is a piston arranged to move in the housing as a cylinder, and
the valve element is formed integrally with the piston.

17. The supercharging apparatus for an engine according to claim 2, wherein
the pressure-operated valve is a piston valve and the operating member is a piston arranged to move in the housing as a cylinder, and
the valve element is formed integrally with the piston.
